(19) United States
(12) Patent Application Publication
(10) Pub. No.: US 2015/0168723 A1
(43) Pub. Date: Jun. 18, 2015

(54) DISPLAY APPARATUS, DISPLAY CONTROLLING METHOD AND PROGRAM

(71) Applicant: Sony Corporation, Tokyo (JP)

(72) Inventors: Hiroaki Eto, Kanagawa (JP); Naomasa Takahashi, Chiba (JP); Masaomi Nabeta, Tokyo (JP)

(21) Appl. No.: 14/405,551

(22) PCT Filed: Apr. 18, 2013
(86) PCT No.: PCT/JP2013/002621

§ 371 Date: Dec. 4, 2014

(30) Foreign Application Priority Data
Jun. 13, 2012 (JP) 2012-133893

(51) Int. Cl. G02B 27/01; H04N 13/04; H04N 9/73; H04N 13/00

(52) U.S. Cl. CPC G02B 27/017; H04N 13/0033; H04N 13/0422; H04N 13/044; H04N 9/73; G02B 2027/0112; G02B 2027/0118; G02B 2027/014; H04N 2213/002

(57) ABSTRACT

According to an illustrative embodiment, a display device is provided. The display device includes a display to display an image; and a video signal processing section to gradually lower an output power, for the image, of light of a wavelength in an approximate range of wavelengths corresponding to blue light, the gradual lowering being performed after a user begins observing the image.

### TECHNICAL FIELD

The present disclosure relates to a display apparatus, a display controlling method and a program. Particularly, the present disclosure relates to a display apparatus, a display controlling method and a program by which display control of reducing the degree of fatigue of a user (observer) who observes a display image of a display section.

### BACKGROUND ART

A display apparatus which is mounted on the head of a user to allow the user to view a video, namely, a head-mounted display (HMD) unit, is widely known. The head-mounted display unit has an optical unit for each of the left and right eyes and is configured such that it is used in conjunction with headphones so that the sense of sight and the sense of hearing can be controlled. If the head-mounted display unit is configured such that the outside world is cut off fully when it is mounted on the head, then the virtual reality upon viewing enhances. Further, the head-mounted display unit can reflect different videos on the left and right eyes, and if images having a parallax are displayed on the left and right eyes, then a 3D image can be presented.

For the display section of the head-mounted display unit for the left and right eyes, a display panel of a high resolution formed, for example, from a liquid crystal display element or an organic EL (Electro-Luminescence) element can be used. Further, if a suitable angle of view is set by an optical system and multi-channels are reproduced by headphones, then such a realistic sensation as is obtained by viewing in a movie theater can be reproduced.

The display section outputs wavelength light of various colors corresponding to videos, and the user (observer) comes to observe output videos of the display sections with the left and right eyes.

Opportunities in which not only such a head-mounted display unit as described above but also various display apparatus such as a portable terminal, a PC or a television set are observed for a long period of time have been and are increasing in recent years. Various analyses have been and are being carried out in regard to the fatigue of the eyes or the body of the user (observer) by such observation of a display apparatus for a long period of time.

For example, as a prior art document which discloses a technology for adjusting the luminance of the display screen in response to the illuminance (environmental light) of the installation environment of a display apparatus, PTL 1 (Japanese Patent Laid-Open No. 2009-86133) is available.

This PTL 1 proposes a video displaying apparatus wherein the dimming speed of the backlight light source is changed so as to follow up a variation of a characteristic amount of an input video signal based on a difference between periods of time required for light adaptation by which a person gets used to bright light and dark adaptation by which a person gets used to dark light.

Meanwhile, PTL 2 (Japanese Patent Laid-Open No. 2010-252379) proposes an image displaying apparatus wherein a peripheral brightness environment is obtained using an illuminance sensor to carry out changeover of video settings suitable for the peripheral environment without providing a sense of discomfort to the viewer.

Further, PTL 3 (Japanese Patent Laid-Open No. 2011-22447) proposes an image displaying apparatus wherein a picture quality correction amount is calculated successively in response to a display luminance level so that it is prevented based on a sense of the brightness and dark adaptation with respect to time of the eyes of the human being, even if the display luminance is controlled, the observer from feeling that the picture quality or the visibility is degraded.

However, both of the prior arts described above implement reduction of the degree of fatigue through adjustment of the luminance of the display section.

Recently, an analysis of causes of fatigue of an observer has proceeded, and it has been reported as a result of the recent study that blue light increases the degree of fatigue of an observer.

In particular, it has been reported that specifically short wavelength light around the blue of a wavelength of approximately 446 nm to 483 nm suppresses secretion of melatonin which is a substance in the brain which relaxes the body, which makes a cause of increasing the degree of fatigue of the observer.

In response to such research results, for example, an experiment wherein protective glasses for cutting blue light are mounted and the like have been carried out, and an examination result that the fatigue of the eyes is reduced has been reported.

From this, in order to reduce the degree of fatigue of the user, it is estimated that it is effective to reduce short wavelength light in the proximity of blue from an output of the display section. However, if only blue light is reduced from a display unit which displays a color image, then the color balance is lost, and there is a problem that a natural color image cannot be observed.

In order to solve such a problem as just described, it is considered that a changing process of an output color utilizing the adaptability of an observer to a variation in color, namely, color adaptability, is effective.

As regards color temperature conversion of changing an output color in accordance with color adaptability, for example, a Bradford transform which is used in a CIECAM02 or ICC profile is known. This transform process is used already, for example, in a printer which executes a printing process of a still picture.

However, this Bradford transform process requires complicated matrix transformation and has a problem in that the processing time period or the hardware cost increases.

To a process for which time may be spent to some degree such as, for example, a printing process of a single still picture, the transform process described above can be applied. However, it is difficult to successively apply this process of a high load to frames of moving pictures, for which an image process for several tens images for one second is required, to carry out color conversion. If a plurality of high-speed processors are incorporated and the apparatus is increased in scale, then also a process ready for moving pictures becomes possible. However, to provide such a function as just described to an apparatus for which reduction in cost and size is required such as a head-mounted display (HDM) unit or a television set, a projector, a PC or a portable terminal gives rise to such a problem as increase in cost or hardware size and therefore is not realistic.

### CITATION LIST

### Patent Literature

[PTL 1]

Japanese Patent Laid-Open No. 2009-86133

[PTL 2]

Japanese Patent Laid-Open No. 2010-252379

[PTL 3]

Japanese Patent Laid-Open No. 2011-22447

### SUMMARY

### Technical Problem

The present disclosure has been made taking, for example, such problems as described above, and it is an object of the present disclosure to provide a display apparatus, a display controlling method and a program which make color temperature conversion utilizing color adaptation possible by a simple and easy configuration and process and implement reduction of the degree of fatigue of a user (observer) who observes a color image.

### Solution to Problem

According to an illustrative embodiment, the technology of the present disclosure is implemented in a display device. The display device includes a display to display an image; and a video signal processing section to gradually lower an output power, for the image, of light of a wavelength in an approximate range of wavelengths corresponding to blue light, the gradual lowering being performed after a user begins observing the image.

Further objects, characteristics and advantages of the present disclosure will be made apparent from more detailed description based on a working example of the present disclosure hereinafter described and the accompanying drawings. It is to be noted that the system in the present specification is a logical assembly configuration of a plurality of apparatus and is not limited to that in which the component apparatus are included in the same housing.

### Advantageous Effect of Invention

According to the configuration of the one working example of the present disclosure, a configuration which makes reduction of the degree of fatigue of a user possible by the color temperature control of a display apparatus is implemented.

In particular, a display apparatus includes a display section configured to output an image signal, and a signal processing section configured to execute control of the image signal to be outputted to the display section. The signal processing section receives sensor information of a mount sensor or the like as an input thereto, measures an elapsed period of time from a point of time at which observation of the display section is started, and then executes control of gradually lowering a color temperature of the image signal in response to an elapsed time period and gradually lowering a signal level in a blue color region. Further, the signal processing section executes control of gradually raising the color temperature of the image signal in response to an elapsed period of time from a point of time at which the observation of the display section ends. The signal processing section executes gain control for input RGB signal values to calculate and output RGB signal values in accordance with chromatic adaptation.

By the present configuration, a configuration which makes reduction of the degree of fatigue of a user possible by the color temperature control of a display apparatus is implemented.

### BRIEF DESCRIPTION OF DRAWINGS

FIG. 1 is a view illustrating an example of a system configuration which utilizes a display apparatus of the present disclosure.

FIG. 2 is a view illustrating an example of a configuration of the display apparatus of the present disclosure.

FIG. 3 is a view illustrating an example of an appearance configuration of the display apparatus of the present disclosure.

FIG. 4 is a view illustrating a configuration and a process of a video signal processing section of the display apparatus of the present disclosure.

FIG. 5 is a view showing a flow chart illustrating a process executed by the display apparatus of the present disclosure.

FIG. 6 is a view illustrating an example of color temperature control executed by the display apparatus of the present disclosure.

FIG. 7 is a view illustrating another example of color temperature control executed by the display apparatus of the present disclosure.

FIG. 8 is a view illustrating a further example of color temperature control executed by the display apparatus of the present disclosure.

FIG. 9 is a view illustrating an example of color temperature control in response to a mode executed by the display apparatus of the present disclosure.

FIG. 10 is a view illustrating another example of color temperature control executed in response to a mode by the display apparatus of the present disclosure.

FIG. 11 is a view showing a flow chart illustrating a process executed by the display apparatus of the present disclosure.

### DESCRIPTION OF EMBODIMENTS

In the following, details of a display apparatus, a display controlling method and a program of the present disclosure are described with reference to the drawings. It is to be noted that the description is given in accordance with the following items.

1. Example of the Configuration of the Image Display System

2. Example of the Configuration of the Head-Mounted Display Unit

3. Details of the Configuration and the Process of the Video Signal Processing Section

4. Details of the Color Temperature Conversion Process of the Color Temperature Conversion Section

5. Working Example Wherein a Different Color Conversion Process Depending Upon a Mode Is Executed

6. Working Example Wherein Luminance Control Is Executed Together

7. Other Working Examples

8. Summary of the Configuration of the Present Disclosure

### 1. Example of the Configuration of the Image Display System

In the following, a working example of a display apparatus of the present disclosure is described.

It is to be noted that, in the following, a head-mounted display unit is described as an example of the display apparatus. However, the process of the present disclosure can be applied not only to a head-mounted display unit but also to various display apparatus such as a television set, a PC, a portable terminal and a projector.

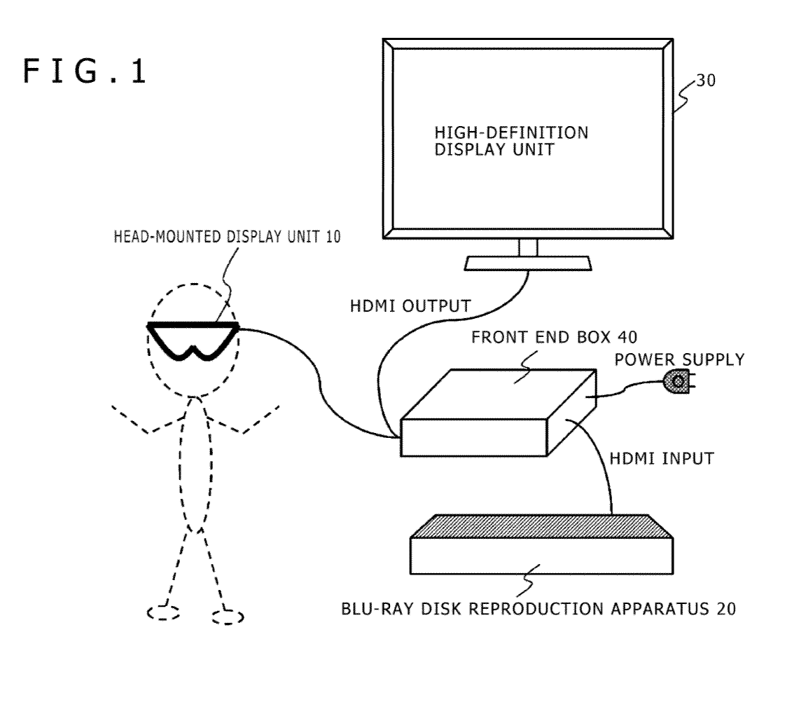

FIG. 1 schematically shows a configuration of an image display system which includes a head-mounted display unit. The system shown in FIG. 1 is configured from a main body of the head-mounted display unit 10, a Blu-ray disk reproduction apparatus 20 serving as a source of viewing content, a high-definition display (for example, HDMI (High-Definition Multimedia Interface) compatible television) unit 30 serving as another outputting destination of reproduction content from the Blu-ray disk reproduction apparatus 20, and a front end box 40 which carries out processing of an AV signal outputted from the Blu-ray disk reproduction apparatus 20.

The front end box 40 corresponds to an HDMI repeater which receives an AV signal outputted from the Blu-ray disk reproduction apparatus 20 as an HDMI input, and carries out, for example, signal processing of the AV signal and then outputs a resulting signal as an HDMI output. Further, the front end box 40 serves also as a two-output switcher which changes over the output determination of the Blu-ray disk reproduction apparatus 20 to one of the head-mounted display unit 10 and the high-definition display unit 30. While the front end box 40 in the example shown in FIG. 1 has two outputs, it may have three or more outputs. However, the front end box 40 exclusively selects an output destination of an AV signal and selects the head-mounted display unit 10 most preferentially as the output destination.

The Blu-ray disk reproduction apparatus 20 and the front end box 40 are connected to each other by an HDMI cable while the front end box 40 and the high-definition display unit 30 are connected each other by another HDMI cable. Although such a configuration that also the front end box 40 and the head-mounted display unit 10 are connected to each other by an HDMI cable can be applied, the AV signal may be transferred serially using a cable of some other specification. However, it is assumed that an AV signal and electric power are supplied by a single cable which connects the front end box 40 and the head-mounted display unit 10 to each other, and the head-mounted display unit 10 can obtain driving power through the cable.

The head-mounted display unit 10 includes display sections for the left eye and the right eye independent of each other. Each of the display sections uses, for example, an organic EL element. Further, each of the left and right display sections includes a lens block configured from a wide view angle optical system of low distortion and a high resolution.

### 2. Example of the Configuration of the Head-Mounted Display Unit

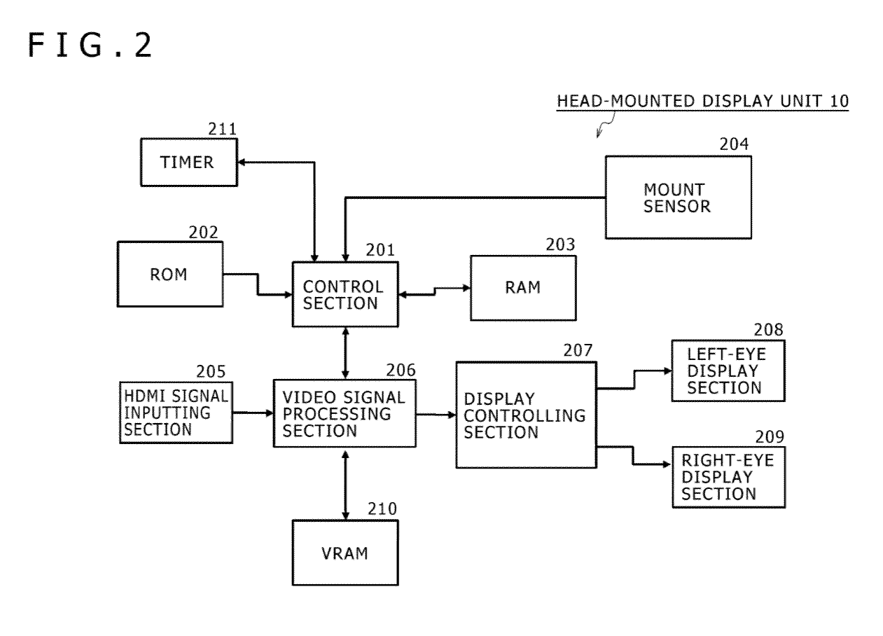

FIG. 2 schematically shows an internal configuration of the head-mounted display unit 10. In the following, components of the same are described.

A control section 201 is configured, for example, from a microprocessor and executes a control program stored in a ROM (Read Only Memory) 202 using a working area of a RAM (Random Access Memory) 203 to control operation of the entire apparatus.

A mount sensor 204 detects that the head-mounted display unit 10 is mounted on a user (viewer) or that the user dismounts the head-mounted display unit 10. When the mount sensor 204 detects mounting or dismounting of the head-mounted display unit 10, it generates an interrupt signal to the control section 201.

In response to this, the control section 201 controls, as a corresponding interrupt process, a timer 211 to start measurement of an elapsed time period from a mounting starting timing or an elapsed time period form a dismounting timing. Further, the control section 201 instructs a video signal processing section 206 to execute conversion of a color signal, for example, a color temperature conversion process, utilizing chromatic adaptation in response to the elapsed time period measured by the timer. Details of this process are hereinafter described.

The video signal processing section 206 carries out such signal processes as decoding, scaling and noise reduction for a video signal received from the front end box 40 by an HDMI signal inputting section 205. Further, the video signal processing section 206 carries out conversion of a color signal, for example, a color temperature conversion process, utilizing chromatic adaptation. The video signal after the processes is temporarily recorded into a VRAM (Video RAM) 210.

A display controlling section 207 outputs a video signal temporarily recorded in the VRAM 210 to a left-eye display section 208 and a right-eye display section 209 so as to be displayed. Each of the left-eye display section 208 and the right-eye display section 209 is provided with a lens block (not shown in FIG. 2) for enlarging the video. Each of the left and right lens blocks is configured from a combination of a plurality of optical lenses and optically processes the video to be displayed by a display panel 224 or 225. Videos displayed on light emitting faces of the left-eye display section 208 and the right-eye display section 209 are enlarged when they pass the lens blocks such that large virtual images are formed on the retina of the user. Then, in the brain of the user who is observing, the left eye image and the right eye image are fused.

Each of the left-eye display section 208 and the right-eye display section 209 is configured, for example, from a liquid crystal display unit or an organic EL element.

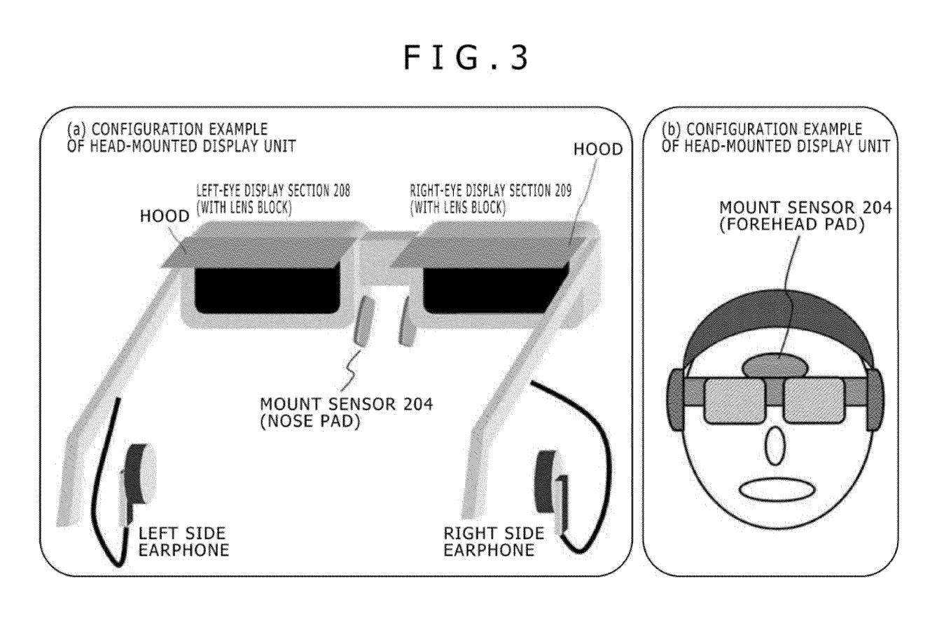

FIG. 3 shows an example of an appearance configuration of the head-mounted display unit 10.

In FIG. 3, two configuration examples including a configuration example (a) wherein the mount sensor 204 is set to a nose pad and another configuration example (b) wherein the mount sensor 204 is set to a forehead pad are shown.

The head-mounted display unit shown in FIG. 3(a) has a structure similar to that of glasses for the visual correction, and the left-eye display section 208 and the right-eye display section 209 are supported on a spectacle frame together with the lens blocks (described hereinabove). Further, to the left and right temples, a left side earphone and a right side earphone are attached, respectively. In the example shown, a nose pad serves also as the mount sensor 204 and is contrived such that it detects mounting when the nose of the user (observer) is abutted with the nose pad. The mount sensor 204 is turned on when the nose of the user is abutted with the nose pad but is turned off when the nose is spaced away from the nose.

In the head-mounted display unit shown in FIG. 3(b), a forehead pad serves also as the mount sensor 204 and is contrived such that it detects mounting when the forehead of the user (viewer) is abutted with the forehead pad. The mount sensor 204 is turned on when the forehead of the user is abutted with the forehead pad but is turned off when the forehead is spaced away from the forehead.

As shown in FIG. 3(a), a hood is attached above each of the left-eye display section 208 and the right-eye display section 209. In a state in which the user mounts the head-mounted display unit 10 thereon, the left and right eyes are blocked from the natural light by the hoods, and the viewing environment can be kept substantially fixed. In other words, the head-mounted display unit 10 is configured as a device for directly covering the eyes of the user.

### 3. Details of the Configuration and the Process of the Video Signal Processing Section

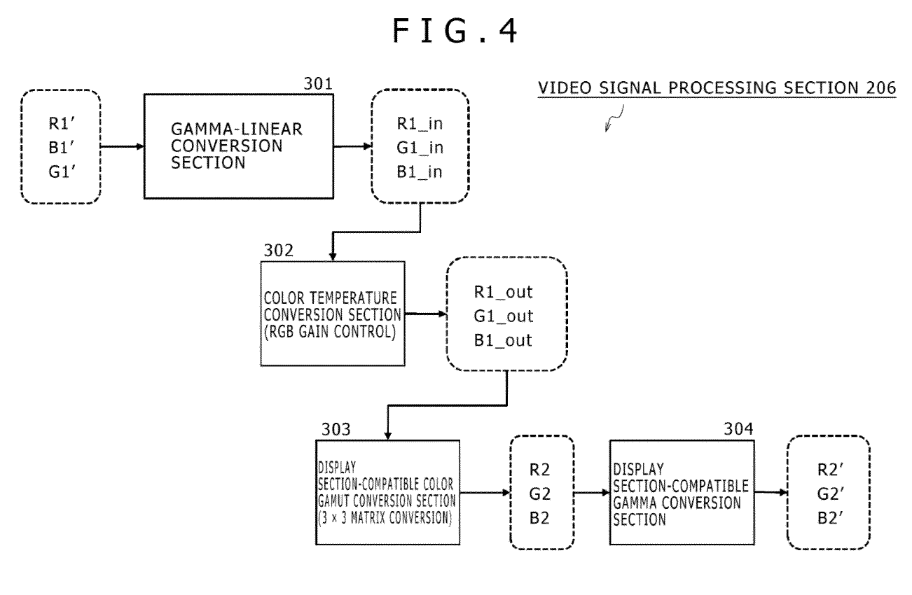

Now, a color signal conversion process executed by the video signal processing section 206 is described with reference to FIG. 4 and so forth.

As described hereinabove with reference to FIG. 2, the video signal processing section 206 carries out signal processes such as decoding, scaling and noise reduction for a video signal received from the front end box 40 by the HDMI signal inputting section 205. Further, the video signal processing section 206 carries out conversion of a color signal, for example, color temperature conversion, utilizing chromatic adaptation.

Such signal processes as decoding, scaling and noise reduction are carried out as processes similar to processes traditionally executed by image displaying apparatus.

In the following, conversion of a color signal wherein chromatic adaptation, which is a process unique to the display apparatus of the present disclosure, is utilized, particularly, a color temperature conversion process, is described.

In the display apparatus of the present disclosure, in the present working example, the video signal processing section 206 of the head-mounted display unit 10 carries out a process of gradually lowering, for example, after the user mounts the head-mounted display unit 10 thereon, the output power of light of a wavelength in the proximity of that of the blue in order to reduce the degree of fatigue of the user. This process is executed as a color temperature conversion process in accordance with chromatic adaptation.

As described hereinabove, blue light increases the degree of fatigue of the observer. In particular, light of a short wavelength in the proximity of that of the blue particularly of approximately 446 nm to 483 nm suppresses the secretion of melatonin which is a substance in the brain which relaxes the body. Therefore, the short wavelength light makes a cause of increasing the degree of fatigue of the observer.

In the display apparatus of the present disclosure, an output of blue color which makes a cause of such fatigue is suppressed, and besides, output color changing in accordance with chromatic adaptation is carried out so that the user may not have a sense of discomfort to the color of a video.

FIG. 4 is a view illustrating an execution configuration and processing of a color signal conversion process executed by the video signal processing section 206. A gamma-linear conversion section 301 carries out a gamma-linear conversion process for video signals (R1′, G1′, B1′) inputted thereto from the HDMI signal inputting section 205 to generate linear RGB signals (R1_in, G1_in, B1_in), for example, of a 14-bit width.

A color temperature conversion section 302 executes a color temperature conversion process utilizing chromatic adaptation for the video signals (R1_in, G1_in, B1_in) of the linear RGB format generated by the gamma-linear conversion section 301 to generate output signals (R1_out, G1_out, B1_out).

“Chromatic adaptation” is experience of the perception of a user (viewer) to a color displayed, for example, on a display section, namely, adaptation.

As the adaptation of a human being to the sense of sight, for example, “light adaptation,” “dark adaptation,” “chromatic adaptation” and so forth are available.

The “dark adaptation” is an autonomic function in an animal which acts when the environment suddenly changes from an environment in which the amount of visible light is great into another environment in which the amount of visible light is small, namely, into a dark environment. In particular, the “dark adaptation” is an adaptation process that, although the animal feels dark first and is placed into a state in which the animal cannot recognize a substance and so forth in the dark environment, as time passes, the animal gradually assures the eyesight.

The “light adaptation” is an autonomic function in an animal which acts when the environment suddenly changes from an environment in which the amount of visible light is small into another environment in which the amount of visible light is great, namely, into a light environment. In particular, the “light adaptation” is an adaptation process that, although the animal feels bright first and is placed also into a state in which the animal cannot in the vicinity recognize a substance and so forth, as time passes, the animal gradually assures the eyesight.

Also the “chromatic adaptation” is an adaptation reaction which is similar to the “light adaptation” and the “dark adaptation” and occurs in the visual part of the human being. For example, if the human being mounts colored sunglasses thereon and looks at white paper, then at the instant, the human being perceives the white paper as paper colored in the same color as that of the sunglasses. However, as time passes, the human being soon becomes to perceive the white paper as white paper.

Such adaptations as the “light adaptation,” “dark adaptation” and “chromatic adaptation” as described above are actions based on an action of photoreceptor cells in the retina. The photoreceptor cells include rod cells which respond to dark and light and cone cells which respond to color (wavelength). The dark adaptation and the light adaptation as well as the chromatic adaptation are adaptation characteristics corresponding to environmental variations of the rod cells and the cone cells.

Incidentally, the rod cell has an extremely high sensitivity to light and responds to even one photon. Since the rod cell shows the sensitivity over the overall region of the spectrum, it exhibits a fixed level of eyesight also at a dark place. On the contrary, in a light environment such as in the daytime, the rod cell is placed into a saturated state with a large amount of light and does not function. The eyesight of the rod cell is low, and delicate discrimination of an object is entrusted to the cone cell. Further, since the rod cells belong to one type wherein a peak is provided at the wavelength of approximately 520 nanometers, it cannot identify a color depending upon a difference in wavelength but identifies only an intensity of light, namely, a difference in brightness. Meanwhile, the cone cell is lower in sensitivity to light than the rod cell and does not function at night when the light is little. Most part of the eyesight is borne by the cone cells and is highest at the macular fovea at which the cone cells are particularly concentrated in a high concentration while the eyesight drops suddenly as the distance from the fovea increases.

The color temperature conversion section 302 of the video signal processing section 206 of the display apparatus of the present disclosure executes a color temperature conversion process utilizing chromatic adaptation for video signals (R1_in, G1_in, B1_in) of the linear RGB format produced by the gamma-linear conversion section 301 to generate the output signals (R1_out, G1_outn, B1_out).

It is to be noted that the color temperature conversion section 302 changes the mode of the color temperature conversion process in response to the following elapsed time periods.

(1) Elapsed time period after starting of mounting of the head-mounted display unit of the user (viewer)

(2) Elapsed time period after dismounting of the head-mounted display unit of the user (viewer)

The control section 201 of the configuration shown in FIG. 2 starts up the timer 211 in response to sensor information of the mount sensor 204, measures the elapsed time period, and changes the processing mode of the color temperature conversion in response to the elapsed time period.

In particular, the following processes are carried out.

(1) In response to the elapsed time period after starting of mounting of the head-mounted display unit of the user (viewer), a process of lowering the output power level of light of wavelengths in the proximity of the blue is carried out gradually.

(2) In response to the elapsed time period after dismounting of the head-mounted display unit of the user (viewer), a process of gradually restoring the output power of light of a wavelength in the proximity of the blue, namely, raising the output power level, is carried out.

It is to be noted that the process of (2) above is a process for suppressing the sense of discomfort when the user mounts the head-mounted display unit thereon again. Both of the color temperature conversions of (1) and (2) above are executed as a process for color temperature conversion in accordance with chromatic adaptation, namely, a process wherein the user (viewer) does not have a sense of discomfort with regard to a variation in color.

It is to be noted that, in the process of the present disclosure, the color temperature conversion section 302 does not carry out complicated matrix arithmetic operation, but applies parameters stored in a memory in advance to execute an arithmetic operation process for an input signal, particularly, for example, gain adjustment for the input signals (R1_in, G1_in, B1_in) to calculate the output signals (R1_out, G1_outn, B1_out) after the color temperature conversion.

A particular process of this color temperature conversion is hereinafter described.

In this manner, the color temperature conversion section 302 of the video signal processing section 206 shown in FIG. 4 carries out a color temperature conversion process utilizing chromatic adaptation for the video signals (R1_in, G1_in, B1_in) of the linear RGB format produced by the gamma-linear conversion section 301 to generate the output signals (R1_out, G1_outn, B1_out).

Then, the output signals (R1_out, G1_outn, B1_out) generated by the color temperature conversion section 302 are inputted to a display section-compatible color gamut conversion section 303.

The display section-compatible color gamut conversion section 303 executes conversion of output bit values in response to a displayable color region of the display section which outputs the video signals, for example, a bit degeneration process of reducing the bit number or the like to generate output values (R2, G2, B2). For this process, an arithmetic operation process wherein a 3×3 matrix stored, for example, in a memory in advance or a like process is carried out.

The RGB values (R2, G2, B2) generated by the display section-compatible color gamut conversion section 303 are inputted to a display section-compatible gamma conversion section 304.

The display section-compatible gamma conversion section 304 carries out gamma correction so as to establish compatibility with characteristics of the display sections, namely, the left-eye display section 208 and the right-eye display section 209 shown in FIG. 2, to generate correction signals (R2′, G2′, B2′) and outputs the correction signals (R2′, G2′, B2′) to the left-eye display section 208 and the right-eye display section 209 shown in FIG. 2.

### 4. Details of the Color Temperature Conversion Process of the Color Temperature Conversion Section

Now, details of the color temperature conversion process executed by the color temperature conversion section 302 of the video signal processing section 206 shown in FIG. 4 are described.

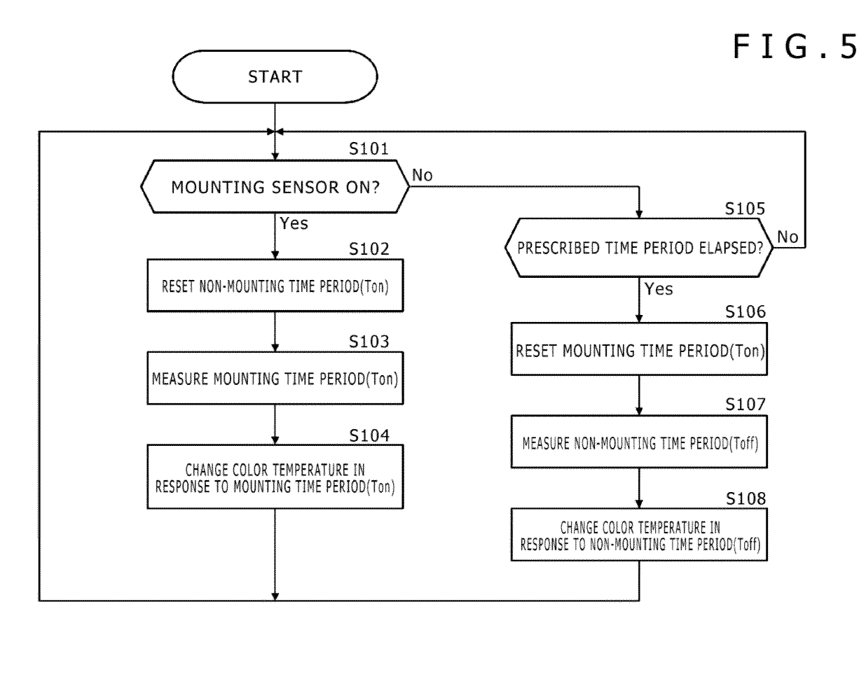

FIG. 5 shows a flow chart illustrating an example of a color temperature conversion process sequence executed by the display apparatus of the present disclosure.

Processing in accordance with the flow illustrated in FIG. 5 is executed such that the display apparatus, for example, the control section 201 of the head-mounted display unit 10 shown in FIG. 2, executes a program stored in the ROM 202 and outputs a control signal to the video signal processing section 206 and so forth. Processes at steps of the flow shown in FIG. 5 are successively described.

(Step S101)

First, the control section 201 decides whether or not the mount sensor 204 is on, namely, whether or not the user mounts the head-mounted display unit thereon, based on the sensor information inputted thereto from the mount sensor 204.

If the control section 201 decides that the mount sensor 204 is on, namely, the user mounts the head-mounted display unit thereon, then the decision at step S101 becomes Yes, and the processing advances to step S102. If the mount sensor 204 indicates an off state, then the decision at step S101 is No, and the processing advances to step S105.

(Step S102)

If it is decided that the mount sensor 204 is on, namely, the user mounts the head-mounted display unit thereon, then the processing advances to step S102, at which the measurement time period measured by the timer 211 after dismounting of the head-mounted display unit is reset.

It is to be noted that the timer 211 measures the elapsed time period from the time at which the user mounts the head-mounted display unit thereon, namely, from the time of starting of mounting at which the mount zensor 204 is turned on, under the control of the control section 201. Further, the timer 211 measures the elapsed time period from the time at which the mount zensor 204 is turned off, namely, from the time of dismounting at which the mount sensor 204 is turned off, under the control of the control section 201.

(Step S103)

At step S103, measurement of the elapsed time period from the time at which the mount zensor 204 is turned on, namely, from the time of mounting at which the user mounts the head-mounted display unit thereon, is started by the timer 211 under the control of the control section 201.

(Step S104)

Then at step S104, the control section 201 outputs a control signal to the video signal processing section 206, and the video signal processing section 206 executes a changing process of the color temperature in response to the elapsed time period from the time of mounting of the head-mounted display unit by the user.

Details of the color temperature changing process executed in response to the elapsed time period from the time of mounting of the head-mounted display unit by the user are described.

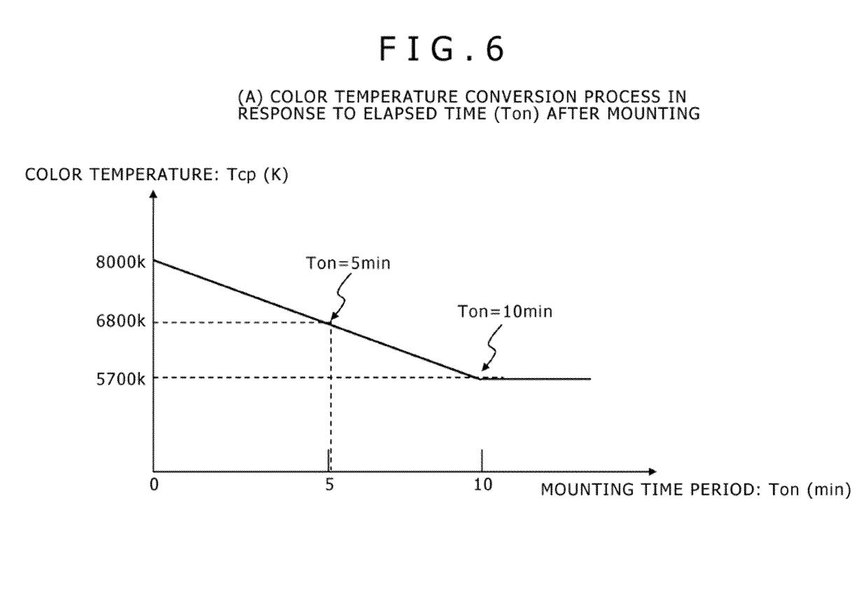

FIG. 6 is a view illustrating a particular example of the color temperature changing process executed in response to the elapsed time period from the time of mounting of the head-mounted display unit, which is executed by the display apparatus of the present disclosure.

The graph shown in FIG. 6 is a graph of such setting that the axis of abscissa indicates the elapsed time period: Ton (min) from the time of mounting of the head-mounted display unit, and

the axis of ordinate indicates the color temperature: Tcp (K) of an image displayed on the display section.

In the case where the elapsed time period from the time of mounting of the head-mounted display unit is zero minute, namely, in the case of

Ton=0,

the color temperature (Tcp) of the display image of the display section is approximately 8,000 K.

This color temperature corresponds to a color temperature of an image for which the color temperature control has not been executed.

In the case where the elapsed time period from the time of mounting of the head-mounted display unit is five minutes, namely, in the case of

Ton=5,

the color temperature (Tcp) of the display image of the display section is approximately 6,800 K.

In the case where the elapsed time period from the time of mounting of the head-mounted display unit is ten minutes, namely, in the case of

Ton=10,

the color temperature of the display image of the display section is approximately 5,700 K.

In this manner, a process of lowering the color temperature together with the lapse of time after the user mounts the head-mounted display unit thereon is executed.

It is to be noted that the process of lowering the color temperature corresponds to a process of lowering blue components in the short wavelength region in the image.

In particular, by lowering the color temperature, blue color components which are considered to suppress secretion of melatonin described hereinabove can be reduced, and an effect that the fatigue of the user (observer) is reduced is achieved.

It is to be noted that, although details are hereinafter described, this color temperature control is executed as a process in accordance with chromatic adaptation of the human being. The user (observer) who is observing the display section can perceive the display image as a natural color display image without having a sense of discomfort to the variation in color.

The control section 201 shown in FIG. 2 inputs the elapsed time period information (Ton) from the time of mounting of the head-mounted display unit, which is measured by the timer 211, to the video signal processing section 206.

The video signal processing section 206 changes the output values of the RGB signals in response to the elapsed time period (Ton) so that such color temperature settings as illustrated in FIG. 6 may be obtained.

In particular, as illustrated in FIG. 4, the color temperature conversion section 302 of the video signal processing section 206 executes the color temperature conversion process for the RGB input values (R1_in, G1_in, B1_in) from the gamma-linear conversion section 301 to generate the RGB output values (R1_out, G1_out, B1_out) and outputs the RGB output values (R1_out, G1_out, B1_out).

The color temperature conversion section 302 executes this RGB output value conversion process by gain control for the RGB input values. In particular,

the RGB output values (R1_out, G1_out, B1_out) are calculated in accordance with the following calculation expression (expression 1).

R1_out=Gr×(R1_in)

G1_out=Gg×(G1_in)

B1_out=Gb×(B1_in) (expression 1)

In the (expression 1) above,

Gr, Gg and Gb are gains corresponding to R, G and B, respectively. In other words, Gr, Gg and Gb are parameters which are multiplied to the input RGB values to calculate output RGB values.

The gain exhibits a value which differs depending upon a color temperature target value which is determined together with the elapsed time period (Ton) from the time of mounting of the head-mounted display unit 10.

For example, in the example illustrated in FIG. 6, the color temperature target value in the case where the elapsed time period Ton from the time of mounting of the head-mounted display unit 10 is Ton=five minutes is 6,800 K.

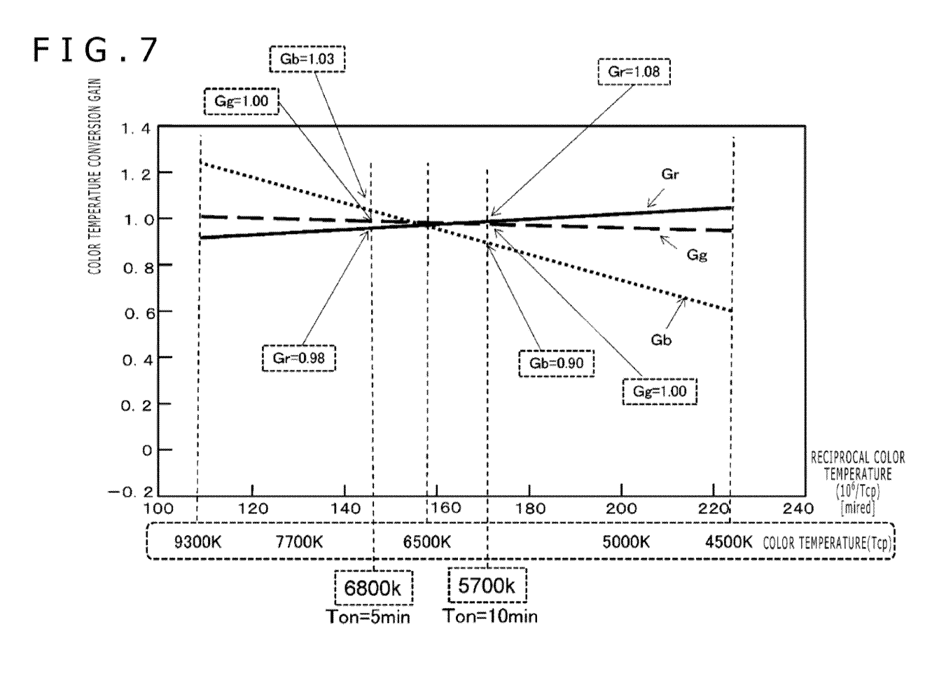

The gain corresponding to each of the RGB colors in this instance has a value determined in accordance with the graph illustrated in FIG. 7.

In the graph illustrated in FIG. 7,

the axis of abscissa indicates the color temperature (Tcp) and the reciprocal color temperature (10⁶/Tcp), and the axis of ordinate indicates the gains (Gr, Gb, Gc). The graphs of FIG. 7 are graphs illustrating corresponding relationships of them.

It is to be noted that the graphs shown in FIG. 7 are graphs produced based on some matrix elements of a transformation matrix used in Bradford transform known as a color temperature conversion process in accordance with chromatic adaptation.

In the Bradford transform process, a 3×3 matrix indicated by the following (expression A) is applied to execute a color temperature conversion process for input RGB values (R1_in, G1_in, B1_in) to produce RGB output values (R1_out, G1_out, B1_out), and the RGB output values (R1_out, G1_out, B1_out) are outputted.

$$\begin{matrix}[ Expression 1 ] & \\ ( \begin{matrix}R\_out \\ G\_out \\ B\_out\end{matrix} ) = ( \begin{matrix}m 11 & m 12 & m 13 \\ m 21 & m 22 & m 23 \\ m 31 & m 32 & m 33\end{matrix} ) ( \begin{matrix}R\_in \\ G\_in \\ B\_in\end{matrix} ) & ( expression A )\end{matrix}$$

A line of Gr shown in FIG. 7 corresponds to the element m11 of the (expression A) above; a line of Gg to the element m22; and a line of Gb to the element m33.

In the Bradford transform process, the 3×3 matrix illustrated in the (expression A) is applied to execute color temperature conversion in accordance with chromatic adaptation.

In the process of the present disclosure, only the elements m11, m22 and m33 of the matrix indicated in the (expression A) given above are applied to execute color conversion.

The elements in the 3×3 matrix indicated in the (expression A) above other than the elements m11, m22 and m33 have values substantially close to zero. Thus, in the process of the present disclosure, a color conversion process is executed only by gain control which utilizes the elements m11, m22 and m33 which have high significance without executing matrix arithmetic operation wherein such elements of almost zero are applied.

By this simplified process, a color conversion process in accordance with chromatic adaptation similar to the Bradford transform process can be achieved.

The process executed by the display apparatus of the present disclosure is executed as a process which utilizes data corresponding to the graphs shown in FIGS. 6 and 7. In particular, a set target value of the color temperature in accordance with the elapsed time period (Ton) from the time of mounting of the head-mounted display unit is calculated from the graph shown in FIG. 6. Thereafter, the gains are calculated from the graphs shown in FIG. 7 based on the acquired target value.

For example, the target value of the color temperature (Tcp) in the case where the elapsed time period from the time of mounting of the head-mounted display unit is Ton=five minutes is 6,800 K. At the position of the color temperature=6,800 K, gain setting is such as

the gain Gr corresponding to R=0.98,

the gain Gg corresponding to G=1.00, and

the gain Gb corresponding to B=1.03.

Further, the target value of the color temperature (Tcp) in the case where the elapsed time period after the time of mounting of the head-mounted display unit is Ton=ten minutes is 5,700 K. At the position of the color temperature=5,700 K, gain setting is such as

the gain Gr corresponding to R=1.08,

the gain Gg corresponding to G=1.00, and

the gain Gb corresponding to B=0.90.

As can be recognized from the graphs shown in FIG. 7, as the color temperature drops, the gain corresponding to the blue color, namely, the gain of Gb, drops.

In particular, in the graph shown in FIG. 7, the inclination of the gain Gb corresponding to the blue color is a rightwardly downward inclination, namely, a (−) inclination, and the blue color is attenuated by lowering the color temperature.

It is to be noted that all of the graphs indicating gain values corresponding to the color temperatures and corresponding to the RGB colors shown in FIG. 7 are straight lines. In other words, the gain values and the reciprocal color temperature (10⁶/Tcp) have a relation of primary expressions.

In particular, the relational expression between the gain value Gx corresponding to a color temperature and corresponding to each of the RGB colors and the reciprocal color temperature (10⁶/Tcp) can be represented by the following expression. In particular, the relational expression is defined by the primary expression:

Gx=p(10⁶/Tcp)+q

It is to be noted that x=one of r, g and b.

p is a value determined in response to Gr, Gb and Gc and is a parameter which corresponds to the gradient of each of the straight lines shown in FIG. 7.

q is a value determined in response to Gr, Gb and Gc and is a parameter which corresponds to the value of each of the straight lines of the reciprocal color temperature (10⁶/Tcp)=0 shown in FIG. 7.

In the case where the values of the parameters p and q determined in response to the gains Gr, Gg and Gc of the RGB have such parameter settings as

parameters corresponding to the gain Gr of R (red): pr, qr,

parameters corresponding to the gain Gg of G (green): pg, qg, and

parameters corresponding to the gain Gb of B (blue): pb, qb,

the color temperature conversion process by the color temperature conversion section 302 can be indicated as an output value calculation process in accordance with an (expression 2) given below.

In particular, the color temperature conversion section 302 shown in FIG. 4 executes color temperature conversion for the RGB input values (R1_in, G1_in, B1_in) to calculate the RGB output values (R1_out, G1_out, B1_out) in accordance with a calculation expression (expression 2) given below.

R1_out=(pr(10⁶/Tcp)+qr)×(R1_in)

G1_out=(pg(10⁶/Tcp)+qg)×(G1_in)

B1_out=(pb(10⁶/Tcp)+qb)×(B1_in) (expression 2)

It is to be noted that the parameters included in the (expression 2) above, namely, the parameters

pr, qr,

pg, qg,

pb, qb,

are stored in a memory in the video signal processing section 206 shown in FIG. 2. Or, the parameters are stored into the RAM 203 of the head-mounted display unit 10 shown in FIG. 2 and provided to the video signal processing section 206 through the control section 201.

Also corresponding relationship information between the elapsed time period (Ton) from the time of starting of mounting of the head-mounted display unit and the color temperature set value shown in FIG. 6 is stored in the memory in the video signal processing section 206 shown in FIG. 2. Or, the corresponding relationship information is stored in the RAM 203 of the head-mounted display unit 10 shown in FIG. 2 and provided to the video signal processing section 206 through the control section 201.

First, the color temperature conversion section 302 of the video signal processing section 206 shown in FIG. 4 receives the elapsed time period (Ton) from the time of starting of mounting of the head-mounted display unit as an input thereto from the control section 201.

The color temperature conversion section 302 utilizes the corresponding relationship between the elapsed time period (Ton) from the time of starting of mounting of the head-mounted display unit and the color temperature set value shown in FIG. 6 to acquire or calculate the set target value (Tcp) of the color temperature based on the elapsed time period (Ton).

Then, the set target value (Tcp) of the color temperature and the parameters

pr, qr,

pg, qg,

pb, qb,

acquired from the memory are applied to calculate the output values after the color temperature conversion, namely, the RGB output values (R1_out, G1_out, B1_out), based on the (expression 2) given hereinabove. In particular, the output values after the color temperature conversion are calculated in accordance with the calculation expression (expression 2) given below.

R1_out=(pr(10⁶/Tcp)+qr)×(R1_in)

G1_out=(pg(10⁶/Tcp)+qg)×(G1_in)

B1_out=(pb(10⁶/Tcp)+qb)×(B1_in)

In this manner, the color temperature conversion section 302 of the video signal processing section 206 shown in FIG. 4 calculates RGB output values after the color temperature conversion in response to the elapsed time period information (Ton) inputted thereto from the control section 201.

The calculated values (R1_out, G1_out, B1_out) are inputted to the display section-compatible color gamut conversion section 303 as illustrated in FIG. 4. The process after this is such as described hereinabove with reference to FIG. 4.

At step S104 of the flow illustrated in FIG. 5, the color temperature conversion process is executed in accordance with the (expression 2) given hereinabove utilizing the color temperature set value determined in response to the elapsed time period (Ton) from the time of starting of mounting of the head-mounted display unit and the parameters (pr, qr, pg, qg, pb, qb) for gain calculation stored in the memory.

After the color temperature conversion process at step S104 is executed, the processing returns to step S101, and in the case where the mount sensor further continues the on state, the processes at steps S102 to S104 are executed repetitively.

By this process, at step S104, the color temperature conversion for setting the color temperatures to the color temperature target values determined in response to the elapsed time period (Ton) from the time of starting of mounting of the head-mounted display unit, namely, to the color temperatures determined in accordance with the graphs shown in FIG. 6.

For example, such a process as to lower the color temperature gradually until ten minutes elapse after the time of starting of mounting and thereafter keep the color temperature fixed as illustrated in FIG. 6 is executed. It is to be noted that the time transition of the color temperature illustrated in FIG. 6 is an example, and some other setting may be used. Further, such a configuration as to carry out a process in response to a mode se by the user or in response to a mode set in response to a category of an image to be displayed may be adopted.

(Step S105)

The process at step S105 is a process executed when the decision at step S101 is No, namely, when the mount sensor is not on.

At step S105, it is decided whether or not a time period prescribed in advance is elapsed. This process is a step for discriminating whether that the mount sensor is turned off arises from the fact that the user dismounts the head-mounted display unit or the fact that the mount sensor is temporality turned off, for example, by vibration.

For example, if the mount sensor is temporarily turned off, then the mount sensor is off within the prescribed time period, and the decision at step S105 is No and the processing returns to step S101.

If the off state of the mount sensor continues for a period of time equal to or longer than the prescribed time period, then it is decided that the user has dismounted the head-mounted display unit, and the processing advances to step S106.

(Step S106)

At step S106, the measurement of the elapsed time period (Ton) from the time of starting of mounting measured by the timer 211 is stopped, and the timer 211 is reset.

(Step S107)

Then at step S107, measurement by the timer 211 from the point of time at which the user dismounts the head-mounted display unit is started. In other words, the measurement of the elapsed time period (Toff) from the point of time at which the user dismounts the head-mounted display unit is started.

(Step S108)

Then at step S108, the control section 201 outputs a control signal to the video signal processing section 206, and the video signal processing section 206 executes a color temperature changing process in response to the elapsed time period after the time of the dismounting of the head-mounted display unit by the user.

Details of the color temperature changing process executed in response to the elapsed time period from the point of time of dismounting of the head-mounted display unit by the user are described.

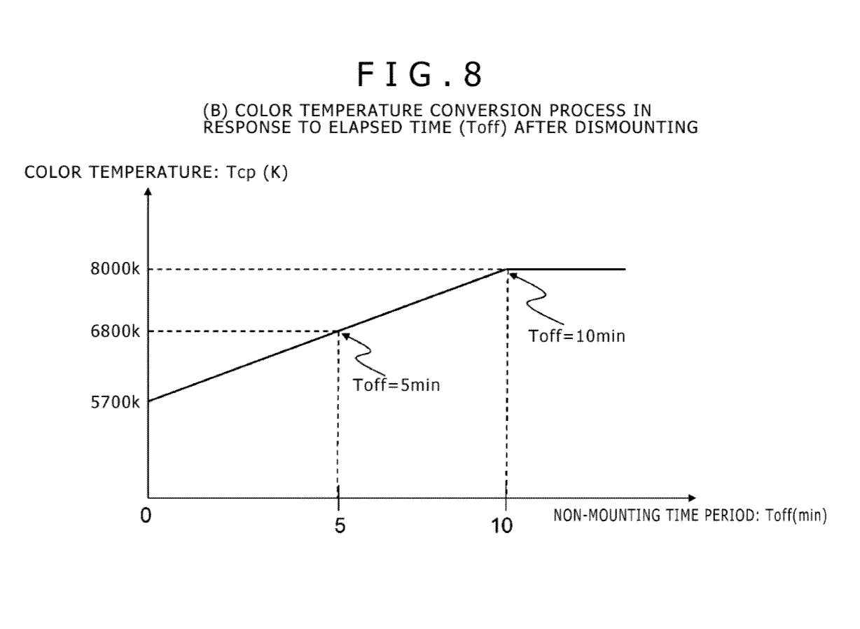

FIG. 8 is a view illustrating a particular example of the color temperature changing process executed by the display apparatus of the present disclosure in response to the elapsed period of time from the time at which the head-mounted display unit is dismounted.

A graph shown in FIG. 8 is set such that the axis of abscissa indicates the elapsed time period from the time of dismounting of the head-mounted display unit, namely, the non-mounting time period: Toff, and the axis of ordinate indicates the color temperature: Tcp (K) of an image displayed on the display section.

In the case where the elapsed time period from the time of dismounting of the head-mounted display unit is zero minute, namely, in the case of

Toff=0,

the color temperature (Tcp) of the display image of the display section is approximately 5,700 K.

This color temperature corresponds, in the setting of FIG. 6 described hereinabove, setting of a color temperature in the case where the mounting time period of the head-mounted display unit continues for more than ten minutes.

The reason why such setting is used is that it is intended to allow, for example, when the user dismounts the head-mounted display unit and then re-mounts the head-mounted display unit immediately, the user to observe an observation image similar to the observation image at the instant of the dismounting thereby to allow the user to observe an image which has no variation before and after the dismounting.

In the case where the elapsed time period from the time of dismounting of the head-mounted display unit is five minutes, namely, in the case of

Toff=5,

the color temperature (Tcp) of the display image of the display section is set to approximately 6,800 K.

If approximately five minutes elapse after the user dismounts the head-mounted display unit, then the eyes adapt to the surrounding environment, and the perceptual state before the mounting of the head-mounted display unit is restored gradually. In the working example illustrated in FIG. 8, conversion to a color temperature at which the original perceptual state of the user is restored fully in substantially ten minutes is executed. In the example illustrated in FIG. 8, under the assumption that, at the point of time after lapses of approximately five minutes after the head-mounted display unit is dismounted, the original perceptual state of the user is not restored fully, the color temperature (Tcp) of the display image of the display section is set to approximately 6,800 K.

For example, if the user re-mounts the head-mounted display unit at this point of time, then the original perceptual state of the user is restored by approximately 50%, and in this perceptual state, the user can observe a color image which does not give a sense of discomfort.

In the case where the elapsed time period from the time of dismounting of the head-mounted display unit is ten minutes, namely, in the case of

Toff=10,

the color temperature of the display image of the display section is set to approximately 8,000 K.

This color temperature corresponds, in the setting of FIG. 6 described hereinabove, to the color temperature setting in the case where the color temperature conversion process is not executed.

In this manner, when the user dismounts the head-mounted display unit, the process of raising the color temperature as the time elapses after the dismounting is executed. This color temperature control is a process in accordance with the chromatic adaptation of the human being, and when the user removes the head-mounted display unit and then re-mounts the head-mounted display unit, the user (observer) can perceive a natural color image without having a sense of discomfort to a variation in color.

The control section 201 shown in FIG. 2 inputs the elapsed time period information (Toff) from the time of dismounting (time of non-mounting) of the head-mounted display unit measured by the timer 211 to the video signal processing section 206.

The video signal processing section 206 changes the output values of the RGB signals so that such color temperature settings as illustrated in FIG. 8 may be obtained in response to the elapsed time period (Toff).

In particular, as illustrated in FIG. 4, the color temperature conversion section 302 of the video signal processing section 206 executes the color temperature conversion process for the RGB input values (R1_in, G1_in, B1_in) from the gamma-linear conversion section 301 to generate and output the RGB output values (R1_out, G1_out, B1_out).

As described hereinabove, the color temperature conversion section 302 executes the color temperature conversion process for the RGB input values (R1_in, G1_in, B1_in) to calculate the RGB output values (R1_out, G1_out, B1_out) in accordance with the following calculation expression (expression 2).

R1_out=(pr(10⁶/Tcp)+qr)×(R1_in)

G1_out=(pg(10⁶/Tcp)+qg)×(G1_in)

B1_out=(pb(10⁶/Tcp)+qb)×(B1_in) (expression 2)

It is to be noted that the parameters included in the (expression 2) above, namely, the parameters

pr, qr,

pg, qg,

pb, qb,

are stored in the memory in the video signal processing section 206 shown in FIG. 2. Or, the parameters stored in the RAM 203 of the head-mounted display unit 10 shown in FIG. 2 are provided to the video signal processing section 206 through the control section 201.

Also corresponding information between the elapsed time period (Toff) from the time of dismounting (time of non-mounting) of the head-mounted display unit and the color temperature set value shown in FIG. 8 is stored in the memory in the video signal processing section 206 shown in FIG. 2. Or, the corresponding information is stored in the RAM 203 of the head-mounted display unit 10 shown in FIG. 2 and provided to the video signal processing section 206 through the control section 201.

First, the color temperature conversion section 302 of the video signal processing section 206 shown in FIG. 4 receives the elapsed time period information (Toff) from the time of dismounting of the head-mounted display unit as an input thereto from the control section 201.

The color temperature conversion section 302 utilizes the corresponding relationship between the elapsed time period (Toff) from the time of dismounting of the head-mounted display unit and the color temperature set value shown in FIG. 8 to acquire or calculate the set target value (Tcp) of the color temperature based on the elapsed time period information (Toff).

Then, the set target value (Tcp) of the color temperature and the parameters

pr, qr,

pg, qg,

pb, qb,

acquired from the memory are applied to calculate the output values after the color temperature conversion, namely, the RGB output values (R1_out, G1_out, B1_out). In particular, the output values after the color temperature conversion are calculated in accordance with the calculation expression (expression 2) given below as described hereinabove.

R1_out=(pr(10⁶/Tcp)+qr)×(R1_in)

G1_out=(pg(10⁶/Tcp)+qg)×(G1_in)

B1_out=(pb(10⁶/Tcp)+qb)×(B1_in)

In this manner, the color temperature conversion section 302 of the video signal processing section 206 shown in FIG. 4 calculates RGB output values after the color temperature conversion in response to the elapsed time period information (Toff) inputted thereto from the control section 201.

The calculated values (R1_out, G1_out, B1_out) are inputted to the display section-compatible color gamut conversion section 303 as illustrated in FIG. 4.

The process after this is such as described hereinabove with reference to FIG. 4.

At step S108 of the flow illustrated in FIG. 5, the color temperature conversion process is executed in accordance with the (expression 2) given hereinabove utilizing the color temperature set value determined in response to the elapsed time period (Toff) from the time of dismounting of the head-mounted display unit and the parameters (pr, qr, pg, qg, pb, qb) for gain calculation stored in the memory as described hereinabove.

After the color temperature conversion process at step S108 is executed, the processing returns to step S101, and it is determined whether or not the mount sensor further remains in the on state. Then, if the mount sensor further remains in the on state, then the processes at the steps beginning with step S102 are executed repetitively, but if the mount sensor is in an off state, then the processes at the steps beginning with step S105 are executed repetitively.

### 5. Working Example Wherein a Different Color Conversion Process Depending Upon a Mode is Executed

In the working example described above, an example wherein setting of a color temperature in response to the elapsed time period (Ton) from the point of time at which the user mounts the head-mounted display unit is executed in accordance with the corresponding relationship illustrated in FIG. 6 is described. Further, an example wherein setting of a color temperature in response to the elapsed time period (Toff) from the point of time at which the user dismounts the head-mounted display unit is executed in accordance with the corresponding relationship illustrated in FIG. 8 is described.

However, the example illustrated in FIG. 6 or 8 is an example, and a configuration wherein a color temperature conversion process is carried out with various different settings in addition to this setting may be adopted.

For example, a configuration wherein changing control of the color temperature which is different depending upon a display mode which can be selected by the user or a mode set automatically in response to content to be displayed on the display section may be adopted.

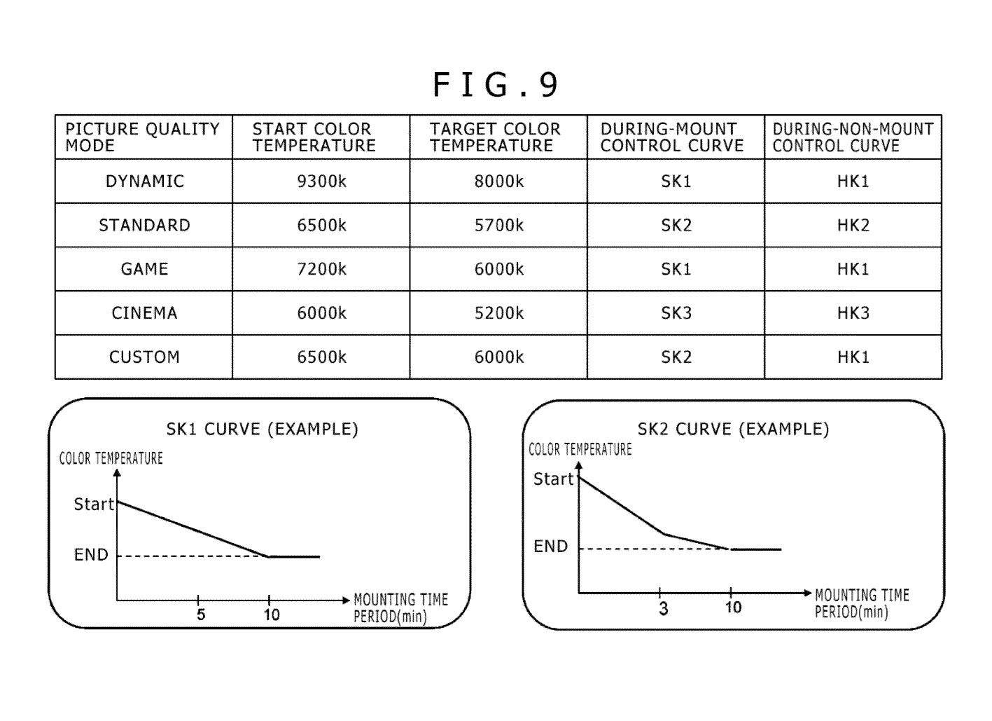

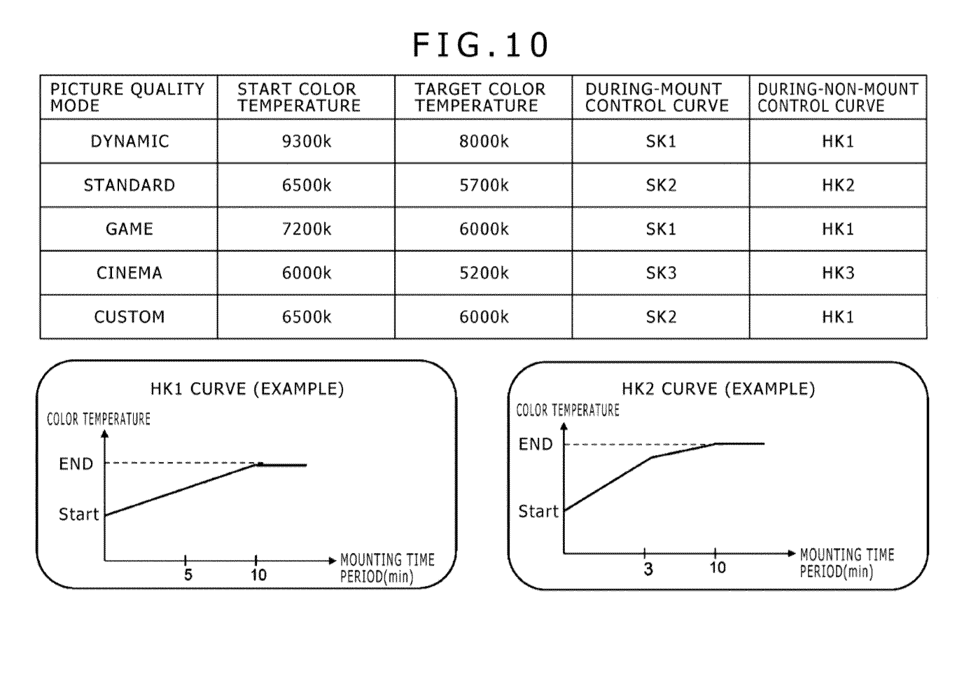

A particular example is described with reference to FIGS. 9 and 10.

For example, a configuration wherein a plurality of modes can be selected as a picture quality mode for display on the display section as illustrated at an upper stage of FIG. 9 is adopted.

In particular, a configuration wherein, as illustrated in FIG. 9,

a dynamic mode,

a standard mode,

a game mode,

a cinema mode, and

a custom mode

can be selected is adopted.

In response to the modes,

a starting color temperature which is a set color temperature at the point of time of starting of mounting of the head-mounted display unit and a target color temperature which is a final color temperature to be set after continuous mounting are set.

Further, in response to the modes, a control curve (SKn) of the color temperature in response to the elapsed time period (Ton) from the point of time of starting of mounting of the head-mounted display unit and a control curve (HKn) of the color temperature in response to the elapsed time period (Toff) from the point of time of dismounting of the head-mounted display unit are set in an associated relationship with each other.

As the control curve (SKn) of the color temperature in response to the elapsed time period (Ton) from the time of starting of mounting of the head-mounted display unit, a plurality of different patterns (n=1, 2, 3, . . . ) are available. The patterns are selected in accordance with the modes.

At a lower stage of FIG. 9, control curves SK1 and SK2 for two different color temperatures in response to the elapsed time period (Ton) from the time of starting of mounting of the head-mounted display unit are shown.

Similarly, also as the control curve (HKn) of the color temperature in response to the elapsed time period (Toff) after the time of dismounting of the head-mounted display unit, a plurality of different patterns (n=1, 2, 3, . . . ) are available. The patterns are selected in accordance with the modes.

At a lower stage of FIG. 10, control curves HK1 and HK2 for two color temperatures in response to the elapsed time period (Toff) after the time of dismounting of the head-mounted display unit are shown.

In this manner, a configuration wherein the color temperature exhibits different transitions with respect to time in response to the modes may be adopted.

### 6. Working Example Wherein Luminance Control is Executed Together

In the working example described above, the working example wherein only color temperature control corresponding to chromatic adaptation is carried out is described. However, a configuration wherein luminance control with the “dark adaptation” and/or the “light adaptation” taken into consideration is executed additionally may be adopted.

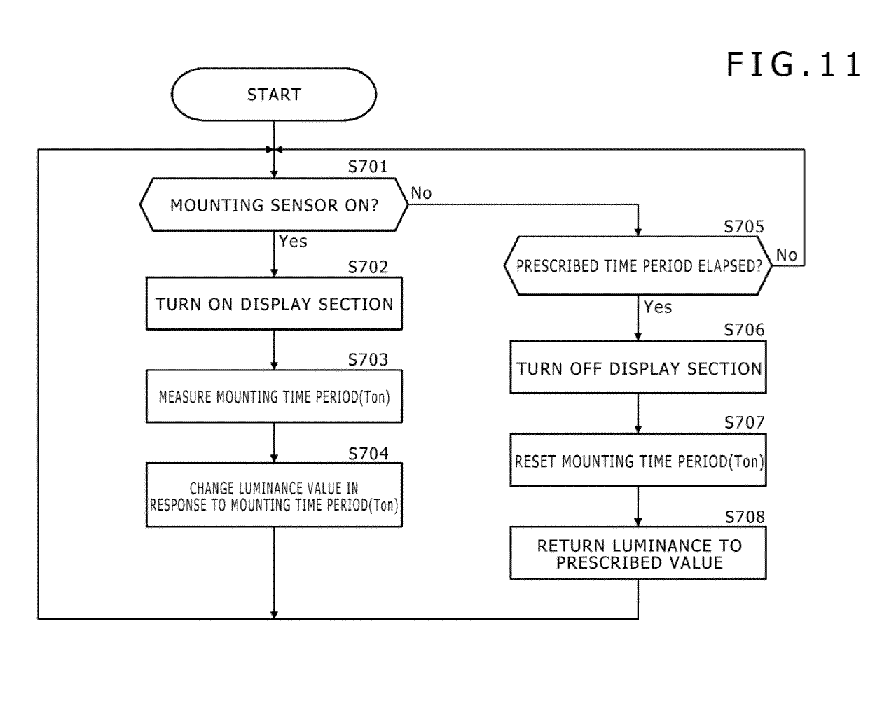

FIG. 11 illustrates, in the form of a flow chart, a processing procedure for carrying out luminance adjustment in response to that the user (viewer) who utilizes the head-mounted display unit 10 mounts or dismounts the head-mounted display unit 10. The illustrated processing procedure is implemented, for example, by the control section 201 executing a control program stored in the ROM 202.

The control section 201 decides in response to a sensor detection signal of the mount sensor 204 whether or not the user (viewer) mounts the head-mounted display unit 10 (step S701).

If it is decided that the user mounts the head-mounted display unit 10 (Yes at step S701), then the control section 201 issues an instruction to turn on the left-eye display section 208 and the right-eye display section 209. In response to the instruction, the left-eye display section 208 and the right-eye display section 209 are turned on with a high luminance (step S702).

Then, the control section 201 counts the elapsed time period after the user mounts the head-mounted display unit 10 (step S703). Then, the control section 201 carries out control of gradually lowering the luminance value of the left-eye display section 208 and the right-eye display section 209 in response to the elapsed time period (step S704).

On the other hand, if it is found at step S701 that the user dismounts the head-mounted display unit 10 (Yes at step S701), then when a period of time (several tens seconds to equal to or less than one minute) set so as to allow the eyes of the observer to become light-adapted elapses (Yes at step S705), the control section 201 issues an instruction to turn off the left-eye display section 208 and the right-eye display section 209. In response to the instruction, the left-eye display section 208 and the right-eye display section 209 are turned off (step S706). Then, the control section 201 resets the mounting time period counted till then (step S707) and returns the luminance value which has been lowered in response to the mounting time period to the original prescribed value (high luminance value) (step S708).

Also when the luminance adjustment for the light adaptation is to be carried out in response to turning off of the mount sensor 204, the luminance is not raised immediately similarly as in the luminance adjustment for the dark adaptation. This is because it is supposed that, depending upon a movement of the head of the observer who mounts the head-mounted display unit 10 thereon, the mount sensor 204 cannot detect normally and may possibly be turned off. If the luminance is raised for the light adaptation in response to that the mount sensor 204 is turned off by a malfunction, then in the visual sensitivity state raised by the dark adaptation, the observer senses glare. Accordingly, until after the period of time set at step S705 elapses, the luminance adjustment for the light adjustment is not carried out. However, at a point of time at which the fixed time elapses, the luminance adjustment for the light adaptation, which is carried out in a shorter period of time than the dark adaptation, is carried out.

With a display apparatus which directly covers the eyes such as a head-mounted display unit having a light blocking property, the user (viewer) is placed in a situation same as that in which the user is at a dark place and, from the visual sensitivity characteristic, dark adaptation occurs with the eyes of the user. By carrying out luminance control of the display section in accordance with the visual sensitivity characteristic, the sense of glare of the viewer can be suppressed. As a result, the viewer can watch for a long period of time with the head-mounted display unit in movie viewing or game playing. Further, by setting the target value of the control luminance to 46 cd/m2 which is a reference value of a digital cinema, when the viewer mounts the head-mounted display unit, it is possible to place the viewer into an environment same as that in viewing in a dark movie theater.

Further, according to the technology of the present disclosure, the head-mounted display unit 10 can place the left-eye display section 208 and the right-eye display section 209 into a state in which the luminance is suppressed further by introducing the user to view in a lower luminance state making use of the dark adaptation. Thus, seizure of the device can be prevented preferably, and as a result, elongation of the life of the entire apparatus can be anticipated.

By executing the luminance control illustrated in FIG. 11 together with the color temperature control flow illustrated in FIG. 5 and described hereinabove, control with not only the “chromatic adaptation” but also the “dark adaptation” and/or the “light adaptation” taken into consideration can be achieved. Thus, not only reduction of the degree of fatigue of the user but also elongation of the life of the display apparatus can be anticipated.

### 7. Other Working Examples

In the working example described above, a head-mounted display unit is described as a representative example of the display apparatus.

However, the color temperature control of the present disclosure can be applied also to other various display apparatus such wife as, for example, a television set, a PC, a portable terminal and a projector.

In the working example described above, the elapsed time period from the time of starting of mounting or the time of dismounting is measured based on the sensor information of the mount sensor provided on the head-mounted display unit, and color temperature control is executed in response to the elapsed time period.

Other display apparatus which do not include the mount sensor such as, for example, a television set, a PC, a portable terminal and a projector can be configured such that, for example, input information by a user is applied in place of sensor information from the mount sensor to carry out color temperature control.

For example, the display apparatus can be configured such that a timing at which observation of an image of the display section is started or stopped is detected in response to a user input to the inputting section and color temperature control is carried out based on an elapsed period of time from the detected timing.

Or, the display apparatus may be configured such that a face detection sensor, a gaze detection sensor or a like sensor which detects that the user directs its eyes to the display section is set to or to the proximity of a face of the display section of the display section such that the sensor detects that the user directs its eyes to the display section. In other words, the display apparatus may be configured such that color temperature control is carried out based on an elapsed time period from the point of time at which it is detected using the sensor that the user directs its eyes to the display section and another elapsed period of time from the point of time at which the user takes its eyes off the display section.

Or, the display apparatus may be configured such that an infrared sensor for detecting the heat of the human body is mounted thereon and the infrared sensor is utilized.

In particular, that the heat of the human being is detected by the infrared sensor is used as detection information similar to that of the turning on of the mount sensor of the working example described hereinabove. Further, when a state in which the heat of the human body is not detected any more by the infrared sensor is detected, this is utilized as detection information similar to that of the turning off of the mount sensor of the working example. The display apparatus may be configured such that the color temperature control is carried out in response to an elapsed time period from these points of time of detection.

### 8. Summary of the Configuration of the Present Disclosure

In the foregoing, the working example of the present disclosure is described in detail with reference to a particular working example. However, it is self-evident that those skilled in the art can carry out modification or replacement of the working example without departing from the subject matter of the present disclosure. In other words, the present invention has been disclosed by way of exemplification and shall not be interpreted restrictively. In order to decide the subject matter of the present disclosure, the claim should be referred to.

It is to be noted that the technology disclosed in the present specification can take the following configurations.

(1) A display apparatus, including:

a display section configured to output an image signal; and

a signal processing section configured to execute control of the image signal to be outputted to the display section, and wherein

the signal processing section

executes control of gradually lowering a color temperature of the image signal in response to an elapsed time period from a point of time at which observation of the display section is started.

(2) The display apparatus according to (1) above, wherein the signal processing section executes control of gradually raising the color temperature of the image signal in response to an elapsed period of time from a point of time at which the observation of the display section ends.

(3) The display apparatus according to (1) or (2) above, wherein the signal processing section carries out a process of gradually lowering the color temperature of the image signal and gradually lowering a signal level in a blue region in response to the elapsed period of time from the time at which the observation of the display section is started.

(4) The display apparatus according to any one of (1) to (3) above, wherein the signal processing section executes a color temperature conversion process by gain adjustment which utilizes individual gain adjustment parameters individually for RGB input values to the signal processing section.

(5) The display apparatus according to (4) above, wherein the signal processing section calculates output RGB signals (Rout, Gout, Bout),

in the case where the RGB input values to the signal processing section are (Rin, Gin, Bin) and

a target color temperature for an output image signal is Tcp,

in accordance with the following expressions:

Rout=Gr×Rin,

Gout=Gg×Gin,

Bout=Gb×Bin,

where Gr, Gg and Gb are gain corresponding parameters individually corresponding to the RGB colors, respectively.

(6) The display apparatus according to (4) or (5) above, wherein the signal processing section calculates output RGB signals (Rout, Gout, Bout),

in the case where the RGB input values to the signal processing section are (Rin, Gin, Bin) and a target color temperature for an output image signal is Tcp,

in accordance with the following expressions:

Rout=(pr(10⁶/Tcp)+qr)×(Rin)

Gout=(pg(10⁶/Tcp)+qg)×(Gin)

Bout=(pb(10⁶/Tcp)+qb)×(Bin)

where pr, qr, pg, qr, pb, qb are gain corresponding parameters individually corresponding to the RGB colors, respectively.

(7) The display apparatus according to (6) above, wherein the gain corresponding parameters pr, qr, pg, qr, pb, qb individually corresponding to the RGB colors are parameters determined based on elements of a color temperature transform matrix in accordance with chromatic adaptation.

(8) The display apparatus according to any one of (1) to (7) above, wherein the display apparatus is a head-mounted display unit and includes a mount sensor configured to detect mounting of the head-mounted display unit and a timer configured to start operation in response to sensor information of the mount sensor, an elapsed time period from the time of starting of observation of the display section, and the signal processing section carries out control of the color temperature of the image signal in response to the elapsed time period measured by the timer.

(9) The display apparatus according to any one of (1) to (8) above, wherein the signal processing section executes the color temperature control of the image signal in a mode which differs depending upon a set mode.

(10) The display apparatus according to any one of (1) to (9) above, wherein the display apparatus further includes a control section configured to control a luminance level of the display section in response to the elapsed time period from the time of the starting of observation of the display section.

(11) A display device, including a display to display an image; and a video signal processing section to gradually lower an output power, for the image, of light of a wavelength in an approximate range of wavelengths corresponding to blue light, the gradual lowering being performed after a user begins observing the image.

(12) The display device according to (11), wherein the image is a moving image.

(13) The display device according to (11), wherein gradually lowering includes gradually lowering an output power of light of a wavelength in an approximate range of 446 nm to 483 nm.

(14) The display device according to (11), wherein gradually lowering is executed only by gain control.

(15) The display device according to (14), wherein gradually lowering is executed only by gain control of gains corresponding to respective color components of the image.

(16) The display device according to (15), wherein gradually lowering is executed only by gain control of gains corresponding to red, green, and blue color components of the image.

(17) The display device according to (11), wherein gradually lowering includes using one or more target color temperatures.

(18) The display device according to (17), wherein gradually lowering is performed according to elapsed time from the time the user begins observing the image, and the one or more target color temperatures are associated with respective elapsed times.

(19) The display device according to (18), wherein a target color temperature of approximately 6,800 K is set for an elapsed time of five minutes.

(20) The display device according to (18), wherein a target color temperature of approximately 5,700 K is set for an elapsed time of ten minutes.

(21) The display device according to (18), wherein gradually lowering is executed only by gain control, and one or more gains are determined according to the target color temperatures.

(22) The display device according to (11), wherein the video signal processing section is operable to gradually increase an output power, for the image, of light of a wavelength in an approximate range of wavelengths corresponding to blue light, after the user has stopped observing the image.

(23) The display device according to (22), wherein the output power of light of a wavelength in an approximate range of wavelengths corresponding to blue light is gradually increased only after a predetermined time has passed from a time that the user stops observing the image.

(24) The display device according to (22), wherein gradually increasing includes gradually increasing an output power of light of a wavelength in an approximate range of 446 nm to 483 nm.

(25) The display device according to (11), wherein the display is a head-mounted display.

(26) The display device according to (25), wherein the head-mounted display includes a mount sensor, and wherein gradually lowering is implemented according to a mount indication provided by the mount sensor.

(27) The display device according to (11), wherein a luminance of the image is gradually decreased after the user begins observing the image, and the luminance of the image is gradually increased following a predetermined period after the user stops observing the image.

(28) A display method, including displaying an image; and gradually lowering an output power, for the image, of light of a wavelength in an approximate range of wavelengths corresponding to blue light, the gradual lowering being performed after a user begins observing the image.

(29) A non-transitory computer-readable medium storing a computer-readable program for implementing a display method, the method including displaying an image; and gradually lowering an output power, for the image, of light of a wavelength in an approximate range of wavelengths corresponding to blue light, the gradual lowering being performed after a user begins observing the image.

(30) A display device, including a display to display an image; and a video signal processing section to gradually lower a color temperature of the image after a user begins observing the image.

(31) The display device according to (30), wherein a luminance of the image is gradually decreased after the user begins observing the image, and the luminance of the image is gradually increased following a predetermined period after the user stops observing the image.

(32) A display method, including displaying an image; and gradually lowering a color temperature of the image after a user begins observing the image.

(33) A non-transitory computer-readable medium storing a computer-readable program for implementing a display method, the method including displaying an image; and gradually lowering a color temperature of the image after a user begins observing the image.

(34) A display device, including a display to display an image; and a video signal processing section to gradually lower spectral content of the image in an approximate range of wavelengths corresponding to blue light, the gradual lowering being performed after a user begins observing the image.

It is to be noted that the various processes described in the specification may not only be executed in time series in the order as described but also be executed in parallel or individually in accordance with the processing capacity of the apparatus which executes the processes or as occasion demands. Further, the system in the present specification is a logical assembly configuration of a plurality of apparatus and is not limited to that in which the component apparatus are included in the same housing.

### INDUSTRIAL APPLICABILITY

As described above, according to the configuration of the one working example of the present disclosure, a configuration which makes reduction of the degree of fatigue of a user possible by the color temperature control of a display apparatus is implemented.

In particular, a display apparatus includes a display section configured to output an image signal, and a signal processing section configured to execute control of the image signal to be outputted to the display section. The signal processing section receives sensor information of a mount sensor or the like as an input thereto, measures an elapsed period of time from a point of time at which observation of the display section is started, and then executes control of gradually lowering the color temperature of the image signal in response to the elapsed period of time and gradually lowering a signal level in a blue color region. Further, the signal processing section executes control of gradually raising the color temperature of the image signal in response to an elapsed period of time from a point of time at which the observation of the display section ends. The signal processing section executes gain control for input RGB signal values to calculate and output RGB signal values in accordance with chromatic adaptation.

By the present configuration, a configuration which makes reduction of the degree of fatigue of a user possible by the color temperature control of a display apparatus is implemented.

The present disclosure contains subject matter related to that disclosed in Japanese Priority Patent Application JP 2012-133893 filed in the Japan Patent Office on Jun. 6, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 Head-mounted display unit
20 Blu-ray disk reproduction apparatus
30 High-definition display unit
40 Front end box
201 Control section
202 ROM
203 RAM
204 Mount sensor
205 HDMI signal inputting section
206 Video signal processing section
207 Display controlling section
208 Left-eye display section
209 Right-eye display section
210 VRAM
211 Timer
301 Gamma-linear conversion section
302 Color temperature conversion section
303 Display section-compatible color gamut conversion section
304 Display section-compatible gamma conversion section

1. A display device, comprising:
a display to display an image; and
a video signal processing section to gradually lower an output power, for the image, of light of a wavelength in an approximate range of wavelengths corresponding to blue light, the gradual lowering being performed after a user begins observing the image.

2. The display device as recited in claim 1, wherein the image is a moving image.

3. The display device as recited in claim 1, wherein gradually lowering comprises gradually lowering an output power of light of a wavelength in an approximate range of 446 nm to 483 nm.

4. The display device as recited in claim 1, wherein gradually lowering is executed only by gain control.

5. The display device as recited in claim 4, wherein gradually lowering is executed only by gain control of gains corresponding to respective color components of the image.

6. The display device as recited in claim 5, wherein gradually lowering is executed only by gain control of gains corresponding to red, green, and blue color components of the image.

7. The display device as recited in claim 1, wherein gradually lowering comprises using one or more target color temperatures.

8. The display device as recited in claim 7, wherein gradually lowering is performed according to elapsed time from the time the user begins observing the image, and the one or more target color temperatures are associated with respective elapsed times.

9. The display device as recited in claim 8, wherein a target color temperature of approximately 6,800 K is set for an elapsed time of five minutes.

10. The display device as recited in claim 8, wherein a target color temperature of approximately 5,700 K is set for an elapsed time of ten minutes.

11. The display device as recited in claim 8, wherein gradually lowering is executed only by gain control, and one or more gains are determined according to the target color temperatures.

12. The display device as recited in claim 1, wherein the video signal processing section is operable to gradually increase an output power, for the image, of light of a wavelength in an approximate range of wavelengths corresponding to blue light, after the user has stopped observing the image.

13. The display device as recited in claim 12, wherein the output power of light of a wavelength in an approximate range of wavelengths corresponding to blue light is gradually increased only after a predetermined time has passed from a time that the user stops observing the image.

14. The display device as recited in claim 12, wherein gradually increasing comprises gradually increasing an output power of light of a wavelength in an approximate range of 446 nm to 483 nm.

15. The display device as recited in claim 1, wherein the display is a head-mounted display.

16. The display device as recited in claim 15, wherein the head-mounted display comprises a mount sensor, and wherein gradually lowering is implemented according to a mount indication provided by the mount sensor.

17. The display device as recited in claim 1, wherein a luminance of the image is gradually decreased after the user begins observing the image, and the luminance of the image is gradually increased following a predetermined period after the user stops observing the image.

18. A display method, comprising:
displaying an image; and
gradually lowering an output power, for the image, of light of a wavelength in an approximate range of wavelengths corresponding to blue light, the gradual lowering being performed after a user begins observing the image.

19. A non-transitory computer-readable medium storing a computer-readable program for implementing a display method, the method comprising:
displaying an image; and
gradually lowering an output power, for the image, of light of a wavelength in an approximate range of wavelengths corresponding to blue light, the gradual lowering being performed after a user begins observing the image.

20. A display device, comprising:
a display to display an image; and
a video signal processing section to gradually lower a color temperature of the image after a user begins observing the image.

21. The display device as recited in claim 20, wherein a luminance of the image is gradually decreased after the user begins observing the image, and the luminance of the image is gradually increased following a predetermined period after the user stops observing the image.

22. A display method, comprising:
displaying an image; and
gradually lowering a color temperature of the image after a user begins observing the image.

23. A non-transitory computer-readable medium storing a computer-readable program for implementing a display method, the method comprising:
displaying an image; and
gradually lowering a color temperature of the image after a user begins observing the image.

24. A display device, comprising:
a display to display an image; and
a video signal processing section to gradually lower spectral content of the image in an approximate range of wavelengths corresponding to blue light, the gradual lowering being performed after a user begins observing the image.
